(19) United States
(12) Patent Application Publication
(10) Pub. No.: US 2025/0115439 A1
(43) Pub. Date: Apr. 10, 2025

(54) TRANSPORT APPARATUS

(71) Applicant: EUROSORT B.V., HV 's-Graveland (NL)

(72) Inventors: Todd Green, Severna Park, MD (US); Matthew Dordai, Baltimore, MD (US); Peter Diamanti, Harleysville, PA (US); Scott Fry, Ellicott City, MD (US); Patrick Theodorus Johannes Van Haaster, De Zilk (NL)

(21) Appl. No.: 18/832,047

(22) PCT Filed: Jan. 24, 2023
(86) PCT No.: PCT/EP2023/051691

§ 371 Date: Jul. 22, 2024

(30) Foreign Application Priority Data
Jan. 25, 2022 (EP) 22153305.2

(51) Int. Cl. B65G 47/04; B65C 9/02; B65C 9/46; B65G 43/08

(52) U.S. Cl. CPC B65G 47/04; B65C 9/02; B65C 9/46; B65G 43/08; B65G 2203/0216; B65G 2203/0233; B65G 2203/0258

(57) ABSTRACT

A transport apparatus comprises a frame, a conveyor, a loading unit and a product transfer device. A first product detector detects a free location at the conveyor, a second product detector detects a product at the loading unit. A controller is configured such that when the first product detector detects a free location and the second product detector detects a product the product transfer device transfers the product from the loading unit to the free location. The loading unit comprises a platform mounted to the frame above the conveyor and tiltable with respect to the frame about an axis of rotation (AR) between a lying product receiving position and a downwardly directed product releasing position, which axis of rotation (AR) is angled with respect to the direction of conveyance. A driving system tilts the platform from the product receiving position to the product releasing position.

### CROSS-REFERENCE TO RELATED APPLICATION(S)

This Application is a 371 National Stage Application of International Application No. PCT/EP2023/051691, filed Jan. 24, 2023 and published as WO 2023/144145 A1 on Aug. 3, 2023, and further claims priority to European Application Ser. No. 22153305.2, filed Jan. 25, 2022.

### BACKGROUND

The present invention relates to a transport apparatus, which comprises a frame, a conveyor for conveying discrete products to be sorted which conveyor is drivable with respect to the frame in a direction of conveyance.

Such a transport apparatus is well-known in the prior art. The conveyor of the known transport apparatus is suitable for conveying discrete products to be sorted. Under operating conditions it will transport discrete products which are located at different locations along the conveyor. In practice there may be several locations at the conveyor which are not occupied and thus suitable for receiving a product to be sorted.

### SUMMARY

An object of the invention is to provide a transport apparatus with high capacity.

This object is accomplished with the transport apparatus according to the invention, which comprises a loading unit for receiving a product which loading unit is located at a position along the conveyor, a product transfer device for transferring a product from the loading unit to the conveyor, a first product detector for detecting a free location at the conveyor for receiving a product, a second product detector for detecting a product at the loading unit and a controller having an input for receiving signals from the first and second product detectors, respectively, and an output for sending a control signal to the product transfer device, wherein the controller is configured such that when the first product detector detects a free location at the conveyor and the second product detector detects a product at the loading unit the product transfer device transfers the product from the loading unit to the free location when the free location passes the loading unit, wherein the loading unit comprises a platform for bearing a product, which platform is mounted to the frame above the conveyor and tiltable with respect to the frame about an axis of rotation between a lying product receiving position and a downwardly directed product releasing position, which axis of rotation is angled with respect to the direction of conveyance, wherein the product transfer device comprises a driving system for tilting the platform from the product receiving position to the product releasing position, hence allowing a product to move downwardly with respect to the platform to the conveyor in a direction which has a component in the direction of conveyance.

An advantage of the transport apparatus according to the invention is that free locations at the conveyor can be provided with respective products such that the capacity of the transport apparatus can be optimized. Since the second product detector detects whether a product is present at the loading unit it is only necessary to supply a product to be sorted to the loading unit. This can be performed manually by an operator, but it is also possible to apply a robot or the like. The second product detector may be configured to detect a unique code of the product that is supplied to the loading unit in order to follow the product during its travelling through the transport apparatus. It is also possible to locate more than one loading unit along the conveyor.

In the lying product receiving position the platform may have such an orientation that a product on the platform will not automatically move from the platform by gravity. In the product releasing position the platform may have such an orientation that a product will automatically move from the platform by gravity. The inclination of the platform in the product releasing position with respect to a horizontal plane is larger than in the product receiving position. For example the inclination in the product releasing position may be 45°, but different angles are possible.

Since the platform tilts from the product receiving position to the product releasing position such that a product on the platform can move downwardly in a direction which has a component in the direction of conveyance the product has already a velocity in the same direction as the direction of conveyance of the conveyor upon arriving at the free location of the conveyor. This provides the opportunity to operate the conveyor at a relatively high speed. In fact, the normal to an upper face or bearing surface of the platform in the product releasing position has a component in the direction of conveyance.

It is noted, that the axis of rotation has a horizontally oriented orientation in order to create the downwardly directed product releasing position.

The conveyor may comprise a plurality of discrete carriers located behind each other in the direction of conveyance, wherein the first product detector is adapted to detect an empty carrier being a free location at the conveyor. Numerous types of carriers are conceivable. For example, each of the carriers may be provided with a tray that is tiltable in order to drop a product at a predetermined location along the conveyor, such as in case of a so-called ‘Bomb-bay’ or ‘split tray’ sorter or a tilt tray or cross tray sorter, but it is also conceivable that a pusher moves the product from the tray, i.e. a push tray sorter.

It is not necessary that the conveyor itself forms a sorter. The conveyor may also supply products to a sorter.

The platform may be transparent in order to provide a product identifier below the platform so as to identify a product that is placed on the platform, for example by reading a barcode.

In the product receiving position of the platform an upper face or bearing surface of the platform may extend substantially horizontally.

The platform may form a bridge above the conveyor. It may be located 50 cm above the conveyor, for example, such that other passing products at the conveyor are not obstructed by the platform when it is in the product receiving position.

In a preferred embodiment the platform is mounted to the frame via a support which is mounted to the frame and tiltable with respect to the frame about the axis of rotation by the driving system, whereas the platform is movable with respect to the support by the driving system in a direction which has a component in the direction of conveyance, since in that case a product on the platform can be accelerated in the product releasing position by gravity as well as by means of the motion of the platform with respect to the support.

The platform may be movable with respect to the support in a direction perpendicular to the axis of rotation.

The controller may be configured such that the driving system tilts the support and moves the platform with respect to the support synchronously.

The controller may be configured such that when the second product detector identifies more than one product at the loading unit the product transfer device is not activated. The controller may additionally raise an alert such that an operator can remove one or more products from the loading unit. It is also possible that the loading unit comprises a mechanism to remove one or more products from the loading unit to a different location than to the conveyor.

The platform may have a flat upper surface so as to allow a product to slide or roll downwardly on the upper surface by gravity when the platform is tilted from the product receiving position to the product releasing position. The upper surface may be smooth to facilitate a sliding movement.

The second product detector may be configured to identify the location of a product on the platform in the direction of conveyance. On the basis of this location information, the timing of activating the driving system and/or the speed of the driving system can be adapted such that the product can be transferred to the free location in an accurate way. For example, the timing of tilting the platform can be advanced or retarded. If the product is placed at the upstream end of the platform instead of in its centre, the start of tilting the platform can be advanced. It is also conceivable to adapt the timing dependent on friction between the platform and the product.

The apparatus may be provided with a third product detector for identifying a location where a released product from the platform arrives at the conveyor. A signal from the third product detector may be a feedback signal to the controller in order to adjust timing of activating the driving system or to adjust the speed of the driving system.

The platform may be provided with one or more guides to guide a product during its movement with respect to the platform during tilting the platform from the product receiving position to the product releasing position. This may force a product to follow a predetermined path to the free location at the conveyor. The guide or guides may be located along lateral edges of the platform. It is also possible that the guide or guides form a converging path in the direction of conveyance, for example a funnel shape.

The distance between the platform and the conveyor may be larger than 50% of the length of the platform as measured in the conveying direction when the platform is in its product receiving position.

The second product detector may be configured to identify a product on the platform, for example by scanning a code on the product, dimensioning the product or weighing the product. Since the product has a temporarily static position on the platform before being transferred to the intended free location at the conveyor there is a time period to perform the mentioned actions. In practice the time period may be relatively long since the frequency that real free locations pass the loading unit, i.e. the free locations to which respective products will be transferred from the platform, will be lower than the frequency that possible free locations pass the loading unit, since a part of the possible free locations will be occupied by a product. For example, in the event that the conveyor comprises a plurality of discrete carriers, in practice only a part of the carriers that pass the loading unit are empty; hence, the frequency that empty carriers pass the loading unit will be lower than the frequency that all carriers, i.e. empty and loaded carriers, pass the loading unit.

For the same reason the apparatus may be provided with means for labelling a product on the platform, for example by printing a code on the product.

### BRIEF DESCRIPTION OF THE DRAWINGS

The invention will hereafter be elucidated with reference to very schematic drawings showing an embodiment of the invention by way of example.

FIG. 1 is a perspective view of a part of an embodiment of a transport apparatus according to the invention.

FIG. 2 is a similar view as FIG. 1, showing an enlarged part thereof in a first condition.

FIG. 3 is a similar view as FIG. 2, showing the part in a second condition.

### DETAILED DESCRIPTION OF THE ILLUSTRATIVE EMBODIMENTS

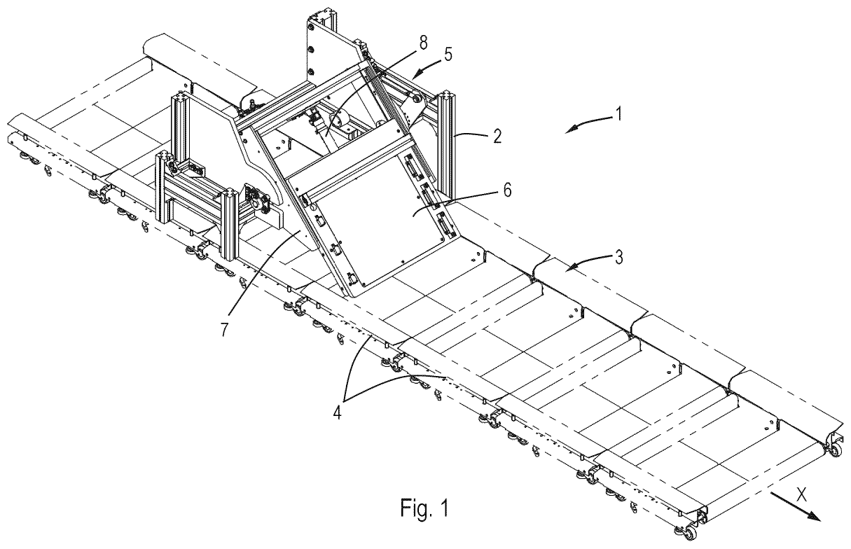

FIG. 1 shows a part of an embodiment of a transport apparatus 1 according to the invention. The transport apparatus 1 comprises a frame 2 and a conveyor 3. The conveyor 3 is drivable with respect to the frame 2 in a direction of conveyance X. The conveyor 3 comprises a plurality of discrete carriers 4 which are coupled to each other and follow a closed loop under operating conditions. The carriers 4 are intended to support and transport respective discrete products such that each carrier 4 supports and transports one product. The conveyor 3 is of a type which is called a ‘Bomb-bay’ or ‘split tray’ sorter. Each of the carriers 4 is provided with tiltable trays which can be opened to drop a product which is destined for a predetermined receiving container (not shown) below the conveyor 3.

The transport apparatus 1 is further provided with a loading unit 5 for receiving a product. The loading unit 5 is located at a certain position along the conveyor 3 and comprises a platform 6 including a flat upper surface for bearing a product. The platform 6 is located above the conveyor 3 and forms a bridge across the conveyor 3. The platform 6 is slidably mounted to a support 7 and movable with respect to the support 7 by means of a first pneumatic cylinder 8. The support 7 is tiltable with respect to the frame 2 about an axis of rotation AR by means of a second pneumatic cylinder 9. The second pneumatic cylinder 9 is pivotally coupled to an arm 10 which is fixed to a shaft that in turn is fixed to the support 7. The axis of rotation AR extends horizontally and perpendicularly to the direction of conveyance X. The platform 6 is movable with respect to the support 7 in a direction perpendicular to the axis of rotation AR. The first and second pneumatic cylinders 8, 9 form part of a product transfer device for transferring a product from the loading unit 5 to the conveyor 3.

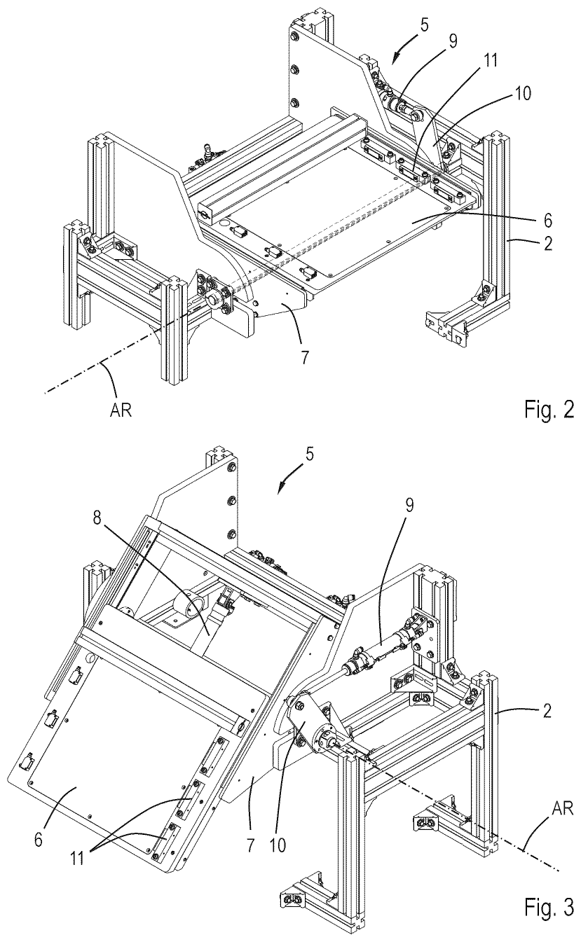

The platform 6 is movable between a lying product receiving position in which the upper surface of the platform 6 extends substantially horizontally, which condition is shown in FIG. 2, and a downwardly directed product releasing position, which condition is shown in FIGS. 1 and 3. In the product receiving position the first and second pneumatic cylinders 8, 9 are retracted and in the product releasing position the first and second pneumatic cylinders 8, 9 are extended. Hence, in the latter condition the platform 6 is tilted about the axis of rotation AR as well as translated with respect to the support 7 in downward direction. When the first cylinder 8 moves from the retracted to the extended position the platform 6 is moved with respect to the support 7 in a direction which has a component in the direction of conveyance X. This means that a product on the platform 6 will be accelerated in the direction of conveyance X by the translative motion, in addition to the acceleration caused by gravity when the platform 6 is inclined with respect to a horizontal plane. This leads to a fast product release, which allows a high velocity of conveyance of the conveyor 3.

Under normal operating conditions a part of the carriers 4 upstream of the loading unit 5 are already provided with a product. These loaded carriers 4 pass the loading unit 5 without tilting the platform 6. Some of the carriers 4 are empty and may be loaded by a product from the platform 6 when passing the loading unit 5. When the platform 6 is moved from the product receiving position to the product releasing position a product that is placed on the platform 6 will slide or roll downwardly with respect to the platform 6 and arrive on an empty carrier 4 which is passing the loading unit 5.

The transport apparatus 1 is provided with a first product detector (not shown) for detecting an empty carrier 4 upstream of the loading unit 5 onto which empty carrier 4 a product from the platform 6 can be transferred. The loading unit 5 is provided with a second product detector 11 for detecting a product on the platform 6. In the embodiment as shown in FIGS. 1-3 the second product detector 11 is formed by three sensors for identifying a product on the platform 6, but this may be different in an alternative embodiment. It is even possible that the platform 6 is transparent and the second product detector is located below the platform 6.

A transparent platform 6 provides the opportunity to locate a product identifier below the platform 6 in order to identify a product that is placed on the platform 6, for example by reading a barcode.

The transport apparatus 1 is also provided with a controller (not shown) for automatically transferring a product from the loading unit 5 to an empty carrier 4. The controller has an input for receiving signals from the first and second product detectors 11 and an output for sending control signals to the first and second pneumatic cylinders 8, 9. The controller is configured such that when the first product detector detects an empty carrier 4 upstream of the loading unit 5 and the second product detector 11 identifies a product on the platform 6 the controller will activate the first and second pneumatic cylinders 8, 9 such that the product will be transferred to the empty carrier 4 when it passes the loading unit 5. The product may be placed onto the platform 6 manually by an operator or automatically by a robot or the like.

The sensors of the second product detector 11 may be positioned in such a way that the controller can identify the location of a product on the platform 6 so as to adapt the timing of activating the first and/or second pneumatic cylinders 8, 9 and/or their speed in dependency of the location of the product.

The controller may be configured such that when the second product detector 11 identifies more than one product at the loading unit 5 the first and second pneumatic cylinders 8, 9 are not activated. In that case an alarm may be generated in order to enable an operator to remove one or more products from the platform 6. It is also possible that a robot automatically removes one or more products from the platform 6.

Since the platform 6 forms a bridge across the conveyor 3 the required distance between the conveyor 3 and the platform 6 in the product receiving position depends on the maximum height of products that are transported by the conveyor 3. It may be 50 cm, for example. In the product releasing position of the platform 6 its upper surface may be inclined by 45° with respect to a horizontal plane, but this may be different. In the latter position a free end of the platform 6 may be close to the conveyor 3, for example a few centimetres above the conveyor 3.

It is noted that when the platform 6 is in the product receiving position and a product is placed on the platform 6 it is easy to apply a label onto the product, since the product has a temporarily static position before being transferred to the intended free location at the conveyor 3.

The invention is not limited to the embodiment shown in the drawings and described hereinbefore, which may be varied in different manners within the scope of the claims and their technical equivalents. For example, the conveyor may have a continuous upper face instead of discrete carriers whereas the first product detector detects an empty portion of the upper face rather than an empty carrier. It is also possible that the loading unit has an additional device for removing a product from the platform in its product releasing position, for example a pushing device.

1. A transport apparatus, comprising:
a frame;
a conveyor configured to convey discrete products to be sorted which conveyor is drivable with respect to the frame in a direction of conveyance;
a loading unit for configured to receive a product which loading unit is located at a position along the conveyor, wherein the loading unit comprises a platform for bearing a product, which platform is mounted to the frame above the conveyor and tiltable with respect to the frame about an axis of rotation (AR) between a lying product receiving position and a downwardly directed product releasing position, which axis of rotation (AR) is angled with respect to the direction of conveyance;
a product transfer device configured to transfer a product from the loading unit to the conveyor, wherein the product transfer device comprises a driving system configured to tilt the platform from the product receiving position to the product releasing position, hence allowing a product to move downwardly with respect to the platform to the conveyor in a direction which has a component in the direction of conveyance;
a first product detector configured to detect a free location at the conveyor for receiving a product;
a second product detector configured to detect a product at the loading unit; and
a controller having an input for receiving signals from the first and second product detectors, respectively, and an output for sending a control signal to the product transfer device, wherein the controller is configured such that when the first product detector detects a free location at the conveyor and the second product detector detects a product at the loading unit the product transfer device transfers the product from the loading unit to the free location when the free location passes the loading unit.

2. The transport apparatus according to claim 1, wherein the conveyor comprises a plurality of discrete carriers located behind each other in the direction of conveyance, wherein the first product detector is configured to detect an empty carrier being a free location at the conveyor.

3. The transport apparatus according to claim 1, wherein in the product receiving position an upper face of the platform extends substantially horizontally.

4. The transport apparatus according to claim 1, wherein the axis of rotation (AR) is substantially perpendicular to the direction of conveyance.

5. The transport apparatus according to claim 1, wherein the platform is mounted to the frame via a support which is mounted to the frame and tiltable with respect to the frame about the axis of rotation (AR) by the driving system, whereas the platform is movable with respect to the support by the driving system in a direction which has a component in the direction of conveyance.

6. The transport apparatus according to claim 5, wherein the platform is movable with respect to the support in a direction perpendicular to the axis of rotation (AR).

7. The transport apparatus according to claim 5, wherein the controller is configured such that the driving system tilts the support and moves the platform with respect to the support synchronously.

8. The transport apparatus according to claim 1, wherein the controller is configured such that when the second product detector identifies more than one product at the loading unit the product transfer device is not activated.

9. The transport apparatus according to claim 1, wherein the platform has a flat upper surface so as to allow a product to slide or roll downwardly on the upper surface by gravity when the platform is tilted from the product receiving position to the product releasing position.

10. The transport apparatus according to claim 1, wherein the second product detector is configured to identify the location of a product on the platform in the direction of conveyance.

11. The transport apparatus according to claim 1, wherein the apparatus is provided with a third product detector for identifying a location where a released product from the platform arrives at the conveyor.

12. The transport apparatus according to claim 1, wherein the distance between the platform and the conveyor is larger than 50% of the length of the platform as measured in the conveying direction when the platform is in its product receiving position.

13. The transport apparatus according to claim 1, wherein the second product detector is configured to identify a product on the platform, for example by scanning a code on the product, dimensioning the product or weighing the product.

14. The transport apparatus according to claim 1, wherein the apparatus is provided with means for labelling a product on the platform, for example by printing a code on the product.
